(19) United States
(12) Patent Application Publication
(10) Pub. No.: US 2009/0234567 A1
(43) Pub. Date: Sep. 17, 2009

(54) METHOD FOR SEARCHING ROUTE IN NAVIGATION SYSTEM

(75) Inventor: Jae Ok Lee, Jungnang-Gu (KR)

Correspondence Address: EDWARDS ANGELL PALMER & DODGE LLP, P.O. BOX 55874, BOSTON, MA, 02205, US

(73) Assignee: HYUNDAI MOTOR COMPANY, Seoul (KR)

(21) Appl. No.: 12/326,414

(22) Filed: Dec. 2, 2008

(30) Foreign Application Priority Data
Dec. 13, 2007 (KR) 10-2007-0129843

(51) Int. Cl. G01C 21/00

(52) U.S. Cl. 701/200

(57) ABSTRACT

The present invention provides a method of searching a route in a navigation system. A method of setting a destination is determined. If, as the result of the determination, the method of setting a destination is determined to be a method of setting a regional destination, one or more link strings corresponding to a group of one or more destination candidates are selected. A single destination is selected from the selected link strings corresponding to the group of destination candidates, and then searched for. The determination of the method of setting the destination is performed by setting a separate flag for setting the regional destination in the memory region of the navigation system.

### CROSS-REFERENCE TO RELATED APPLICATIONS

This application claims priority to Korean Application No. 10-2007-0129843 filed on Dec. 13, 2007, the disclosure of which is incorporated herein by reference.

### BACKGROUND

1. Technical Field

The present disclosure relates to a method for searching a route in a navigation system which provides a map including a destination and/or a route to the destination to help a user drive a car and/or find a route.

2. Background Art

A navigation system is a device that shows the present location of a user and finds a route to a destination designated by the user using a Global Positioning System (GPS). In a navigation system, a preferred route between an origin location and a destination location may be searched for an optimal path through a collection of nodes and links that represents a network of roads and intersections. Each node of the graph represents an intersection of two or more roads and each link represents a path segment connecting two nodes. A path or route for reaching a destination is constituted by a consecutive string of links properly searched.

In such a navigation system, a point on a road is designated by a user as a destination or a departure point. In certain cases, whether the point exists on the right side or left side of the road has considerable significance.

Whether the destination exists on the left or right side of the road is no or less important for a road crossing the center line of which is allowed. However, it is important for a road crossing the centerline of which is not allowed. That is, if a point the navigation system shows by the user as a destination point is on the opposite side of a lane the user is traveling on, the user must search a route again in order to reach the destination, and thus as shown in FIG. 1, the system makes the user take a U-turn to lead him to the destination point, which may dissatisfy the user and decrease the reliability of the navigation system.

FIG. 1 is a view showing a method of providing information about a route to a destination in consideration of a traveling direction in conventional navigation systems.

The conventional navigation systems store attributes related to whether roads can be crossed based on the attributes of the roads in map data, and guide, based on the stored attributes, the user to a destination on the road that a car can cross, regardless of the traveling direction of the car.

For a road crossing the center line of which is not allowed, when a car is traveling on the right side of the center line and a destination point is on or near the left side, the conventional navigation systems provide search result in consideration of the traveling direction, as shown in FIG. 1.

The conventional navigation systems, however, have some drawbacks. One of the drawbacks is that search result provided in consideration of a traveling direction may not be appropriate, for example, in a case where a subway station or an intersection(a point where a plurality of roads crosses) is designated as a destination.

More specifically, in the case in which a user sets a specific subway station as a destination, the exits of a subway station may exist in all corners of an intersection, and the exits of the subway station may also exist on both sides of the road even in the case in which the station is not located at the intersection. There may be two or more directions from which the user can reach a particular exit.

When a user wants to arrive at such a certain region as a subway station or an intersection whose area is broader than an exact point, usually, the user may not be interested in any specific direction of reaching the region, but only be interest in just reaching the region and, thus, the user does not designate any specific direction to go to the region.

However, since the conventional navigation systems do not have a proper determining or notifying system to show whether the user is reached the regional destination, they cannot but set a proper corresponding point where is near the region as single point coordinates, accordingly, the link or links that are the closest to the point coordinates and the direction of the link must be selected. In this case, two directions must be selected from among four directions in which a car can enter an intersection.

As shown in FIG. 2, when assuming that a driver wants to reach a regional destination, an intersection P, and the target point “X” is set in the corner of the third quadrant III as a substitution for the regional destination P, if a car moves toward the intersection P in the direction ‘c’ or ‘d’, it is anticipated that the car will arrive on the side opposite a destination marked as “X.” Therefore, the navigation system will perform a search and provide a search result that guides the car, for example, to make a U-turn at a near arbitrary node(not shown) to finally enter in the direction ‘a’ or ‘b’, as shown in FIG. 1.

Furthermore, if an intersection is designated as a regional destination, the car may have to make three-consecutive-right-turn around a block to reach the destination, as shown in FIG. 3, this results in passing the destination(intersection) twice.

The above information disclosed in this Background section is only for enhancement of understanding of the background of the invention and therefore it may contain information that does not form the prior art that is already known in this country to a person of ordinary skill in the art.

### SUMMARY

Accordingly, the present invention has been made keeping in mind the above problems occurring in the prior art, and an object of the present invention is to provide a method for searching a route in a navigation system which can set a destination that cannot be defined based on single coordinates, thereby enabling the user of the navigation system to more conveniently and accurately reach the designation, particularly, regional destination by avoiding redundant maneuver of search.

In one aspect, the present invention provides a method of searching a route in a navigation system. The method comprises (a) determining a method of setting a destination, (b) if it is determined that the destination to be set is a regional destination, selecting one or more links corresponding to a group of one or more destination candidates, and (c) selecting and searching a single destination from the selected link or links corresponding to the group of destination candidates.

Preferably, the step (a) may be performed by setting a separate flag as a target point of designation for the regional destination in a memory region of the navigation system.

Examples of the regional destination include a subway station or an intersection.

A paths(routes) corresponding to the group of destination candidates may suitably comprise all consecutive strings of link which are included in a radius preset in a vicinity of coordinates of the destination, and directions in which the respective strings of link are oriented toward the destination, based on the coordinates of the destination.

Suitably, the step (c) may be performed by selecting an arbitrary route(a string of links) from among the plurality of candidate routes and, in a case in which the link or links belonged to the selected route is passed by, removing the link or links that have been passed by before reaching the selected destination link from the destination candidates.

In a further aspect, the present invention provides a computer readable record medium recording a program for implementing the above-described methods.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing a method of providing information about a route to a destination in consideration of a vehicle traveling direction in conventional navigation systems;

FIG. 2 is a view showing the determination of a traveling direction based on the coordinates of an intersection in the conventional navigation systems;

FIG. 3 is a view showing an example of an erroneous search that may occur in the case in which an intersection is designated as a destination in the conventional navigation systems;

FIG. 4 is a view showing a method of selecting a plurality of destination links according to an embodiment of the present invention;

FIG. 5 is a schematic view showing a process of searching and determining a route among a plurality of candidate routes by avoiding redundant maneuver of search according to an embodiment of the present invention;

FIG. 6 is a flowchart showing the sequence of searching and determining a route to a regional destination that cannot be defined based on single coordinates according to an embodiment of the present invention; and

FIG. 7 is a view showing a process in which a group of multiple destination candidates is referred to from memory for storing the group of multiple destination candidates according to an embodiment of the present invention.

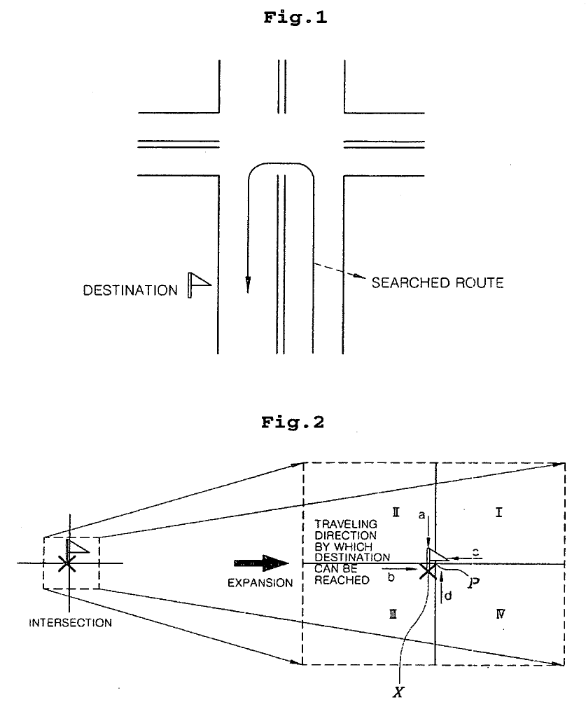

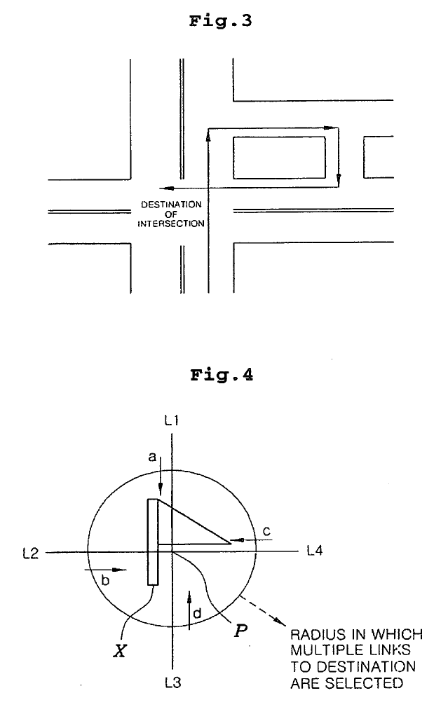

### DETAILED DESCRIPTION

Preferred embodiments of the present invention will be described in detail with reference to the attached drawings below. The same reference numerals are used throughout the different drawings to designate the same or corresponding components, and duplicated descriptions thereof will be omitted.

As described above, there is provided a method of setting a destination that cannot be defined based on single coordinates and searching a route to the destination. The destination may be set in various ways. For example, the name of a subway station, the name of an intersection, and the names of two roads crossing each other can be uses.

Here, the single coordinates is an element for determining a single traveling direction of a single link, and has the concept identical to the case in which a single link and a single traveling direction are set for a destination, as used in conventional navigation systems with Geographic Information System (GIS). As discussed above, the conventional navigation systems using such single coordinates has a problem that it may produce search results inappropriately.

According to a preferred embodiment of the present invention, a route is searched using a group of multiple destination candidates. For this, a destination is determined and links to the destination are then selected.

The destination may be selected by various ways. For example, it can be selected by searching a general address, designating a specific Point Of Interest (POI), or browsing a map.

In this case, a conventional method of selecting a single link and a single traveling direction is used.

In the case in which a subway station or an intersection is designated as a destination by entering the name of the subway station or intersection or the names of two roads crossing each other at the intersection, a separate flag may suitably be set for setting a regional destination in a memory region of a navigation system.

If a flag is set at the position “X” as a target point of the designation for setting a regional destination, a group of multiple route candidates is selected based on the coordinates of the regional destination. According to a preferred embodiment, all of the links and directions in which the respective links are oriented toward the regional destination and extended over a specific radius (for example, 10 m) in the vicinity of the coordinates of the regional destination are selected as a group of destination candidates.

FIG. 4 shows links L1(a), L2(b), L3(d), and L4(c) corresponding to a group of selected destination candidates, the letter in the parenthesis denoting the vehicle approaching direction to the regional destination P. It is noted that each of the four links L1(a), L2(b), L3(d), and L4(c) shown in FIG. 4 may be a final link to reach the destination P, respectively, and followed by its respective string of prior links(not shown). One or more strings of link corresponding to the group of the selected destination candidates are transmitted to a route search module. The route search module stores the strings of link in a separate memory region and uses them for a route search process in the future to remove one or more unnecessarily duplicated links as described in detail below.

When strings of link are selected, a route is searched using the group of selected multiple destination candidates by which search results can be obtained in a shorter time.

Each of the plurality of routes can be selected as a destination and the corresponding links can then be separately searched. But obtaining search results in this way takes much time.

In order to prevent this, according to an embodiment, the group of multiple route candidates including the respective final link is stored in a memory, one (L1) of them is selected as a destination, and then a search is performed in the same manner as in a single destination.

In the case in which the link L2, for example, among the plurality of final links, stored in the memory, is passed by in the vicinity of the destination during the search process, the route from beyond the link L1 to immediately before the link L2 is removed from the search result.

As described above, the present methods and systems can solve the problem associated with the conventional navigation systems of providing an abnormal search result which causes the user to pass by a destination and returned to the destination again.

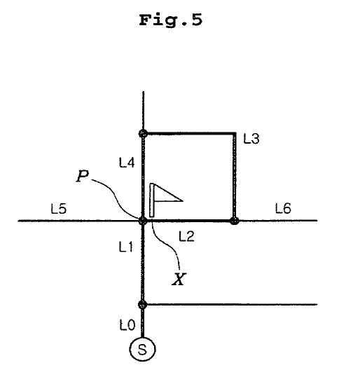

FIG. 5 is a schematic view to show a process of searching a route using a group of multiple destination candidates.

As shown in FIG. 5, links L1, L2, L4, and L5 are stored as segments to form a group of multiple destination candidates.

It is assumed for the purpose of explanation that a flag is set at the position “X”(in the first quadrant) as a target point of the designation for a regional destination P, and the link L2 is selected for reaching the target point “X” in a searching process as a link corresponding to an initial destination and that a route is searched along the routes L2→L3→L4→L1→L0 to a starting point “S”. The route search module reaches the link L4 through the link L3, and if Is the route search module senses that the link L4 is a link stored in the group of multiple destination candidates, it removes all the segments(links) of the route(L2→L3) that have been passed by before reaching the link L4.

The route search module then proceeds the search process from the link L4 to the link L1, and if the route search module senses that the link L1 is a link stored in the group of multiple destination candidates, it removes all the segments(links) of route (L4) that have been passed by before reaching the link L1.

Thereafter, until the process reaches a starting point ‘S’, no link stored in the group of multiple destination candidates is passed by, so that the final segments(links) of the route to the starting point becomes L1→L0. By this way, redundant maneuver of the search can be avoided so that the driver can reach the regional destination P through the route L1→L0.

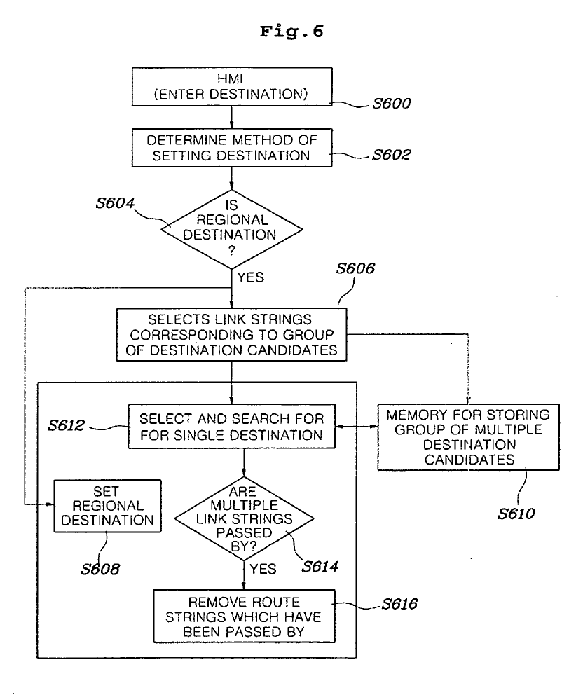

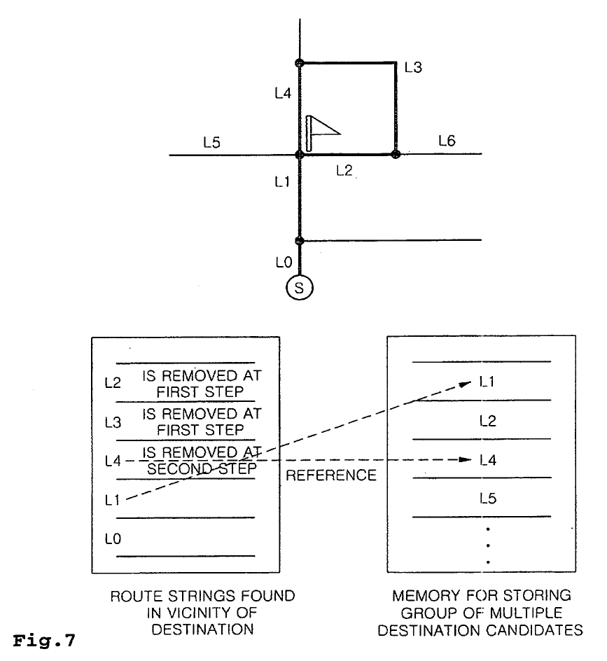

The whole sequence in which a route is searched in a navigation system according to the present invention will be described in more detail with reference to FIGS. 6 and 7.

FIG. 6 is a flowchart showing the sequence of searching a route to a destination that. cannot be defined based on single coordinates according to an embodiment of the present invention.

First, when a user selects a destination through a Human Machine Interface (HMI) at step S600, a navigation system determines a method of setting the destination at step S602.

Whether the destination to be set is a regional destination is determined at step S604. If it is determined that the destination is a regional destination (e.g., the destination is a subway station or an intersection), a flag for setting the regional destination is set up at step S608.

When the flag is set up, one or more routes(strings of link) including the final link in the vicinity of the longitude and latitude of the regional destination are selected, at step S606, by the same method as described with regard to FIG. 5.

At step S610, the selected plurality of routes are separately stored in a memory for storing the group of multiple destination candidates.

Meanwhile, the memory for storing the group of multiple destination candidates may be a memory of the navigation system. This memory is referred to when the route search module searches a route.

The route search module selects one of the plurality of links stored in the memory as a link to a destination, and searches a single destination at step S612.

If the single destination is searched, the route search module determines whether a link or links found in the vicinity of the destination are included in the group of route candidates by referring to the plurality of links to stored in the memory whenever a single link is selected to search a single destination (S612).

Whether a searched route in the vicinity of the destination passes by any link included in the group of multiple destination candidates is determined at step S614. All the prior links that have been passed by before reaching the link included in the group of candidates are removed from the links to the destination at step S616.

FIG. 7 is a diagram to show the procedure of removing one or more links that have been passed by before reaching the corresponding link at the step S616 of FIG. 6, and the process of removing the link or links found in the vicinity of the destination (FIG. 5) from the routes when the link or links are determined to be included in the group of candidates by referring to the memory for storing the group of multiple destination candidates.

Referring to FIG. 7, at a first step, the link L4 is found in a list in the memory for storing the group of multiple destination candidates. The segments of the route including the links L2 and L3 are found before the link L4 and are thus removed.

Thereafter, a search is successively performed in the direction from the link L4 to the link L1. The link L1 is found in the list in the memory for storing the group of multiple destination candidates. The link L4 is found before the link L1 (the links L2 and L3 have already been removed at the first step) and is thus removed at a second step.

Thereafter, since none of the links included in the group of multiple destination candidates is passed by before the starting point, the searched route is not removed.

As described above, the link or links of the route passed by in the vicinity of a destination are removed, and then one or more unnecessary traveling links are removed after the destination is finally reached, so that undesired and unnecessary duplicated routes can be effectively removed when a regional destination is set as a destination.

Meanwhile, although a description of the configuration of a navigation system, which is obvious to those skilled in the art, has been omitted in the above description, the navigation system may include an input unit for receiving destination information, a route search unit for searching a route, memory for storing map information or a group of multiple destination candidates according to the present invention, and a display screen for displaying a map. It will be apparent that the method of searching a route according to the present invention can be performed by such a navigation system.

The above-described methods may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

As described above, the methods and devices for searching a route in a navigation system according to the present invention have an advantage of enabling a regional destination that cannot be defined based on single coordinates to be set and then a route to the destination to be searched.

Further, there is an advantage in that a route to a destination that cannot be defined based on single coordinates can be searched, so that the user of the navigation system can more conveniently and accurately reach the destination.

Although the preferred embodiments of the present invention have been. disclosed for illustrative purposes, those skilled in the art will appreciate that various modifications, additions and substitutions are possible, without departing from the scope and spirit of the invention as disclosed in the accompanying claims.

What is claimed is:

1. A method of searching a route in a navigation system, comprising the steps of:
(a) determining a method of setting a destination;
(b) if it is determined that the destination to be set is a regional destination, selecting one or more links corresponding to a group of one or more destination candidates; and
(c) selecting and searching a single destination from the selected link string or strings corresponding to the group of destination candidates.

2. The method as set forth in claim 1, wherein step (a) is performed by setting a separate flag for setting the regional destination in a memory region of the navigation system.

3. The method as set forth in claim 1, wherein the regional destination is a subway station or an intersection.

4. The method as set forth in claim 1, wherein the strings corresponding to the group of destination candidates comprise all links which are included in a radius preset in a vicinity of coordinates of the destination, and directions in which the respective links are oriented toward the destination, based on the coordinates of the destination.

5. The method as set forth in claim 1, wherein step (c) is performed by selecting an arbitrary one from among the plurality of link strings as a destination link, and, in a case in which the selected destination link is passed by, removing link string or link strings that have been passed by before reaching the selected destination link from the destination link strings to the destination.

6. A computer readable record medium recording a program for implementing the method according to claim 5.
